(19) United States
(12) Patent Application Publication
(10) Pub. No.: US 2024/0317241 A1
(43) Pub. Date: Sep. 26, 2024

(54) DRIVER ASSISTANCE RECOMMENDATIONS USING SENSOR DATA ASSOCIATED WITH A LOWER EXTREMITY REGION

(71) Applicant: QUALCOMM Incorporated, San Diego, CA (US)

(72) Inventor: Carl Victor LJUNGSTRÖM, Ljungsbro (SE)

(21) Appl. No.: 18/188,279

(22) Filed: Mar. 22, 2023

(51) Int. Cl. B60W 40/08; B60Q 9/00; B60W 50/14

(52) U.S. Cl. CPC B60W 40/08; B60Q 9/00; B60W 50/14; B60K 28/04; B60W 2040/0881; B60W 2050/146; B60W 2540/10; B60W 2540/12; B60W 2540/223; B60W 2720/10

(57) ABSTRACT

In some aspects, a device may obtain sensor data associated with a driver control region of a vehicle. The device may detect, based on the sensor data, one or more sensor detections associated with one or more lower extremities of a driver of the vehicle. The device may determine, based on the one or more sensor detections, one or more reaction time risk indicators. The device may estimate, based on the one or more reaction time risk indicators, a driver reaction time associated with the driver of the vehicle. The device may perform one or more actions based on at least one of the driver reaction time or the one or more reaction time risk indicators. Numerous other aspects are described.

### FIELD OF THE DISCLOSURE

Aspects of the present disclosure generally relate to vehicle sensors and, for example, to driver assistance recommendations using sensor data associated with a lower extremity region.

### BACKGROUND

A vehicle may include a sensor system that includes one or more sensors to determine characteristics associated with the vehicle, characteristics associated with a driver of the vehicle, and/or characteristics associated with an environment of the vehicle. For example, such a sensor system may be configured to detect proximity to an object, a weather condition, a road condition, a vehicle speed, a traffic condition, and/or a location of the vehicle, among other examples. For example, sensors, such as radar sensors, cameras, and/or light detection and ranging (LIDAR) sensors, among other examples, are often employed on devices or systems, such as vehicles, mobile devices (e.g., a mobile telephone, a mobile handset, a smart phone, and/or other mobile device), among other devices and systems. One example of using sensors is for enhanced vehicle safety, such as adaptive cruise control (ACC), forward collision warning (FCW), collision mitigation or avoidance via autonomous braking, pre-crash functions (e.g., airbag arming or pre-activation), an advanced driver assistance system (ADAS) operation, an automated driving system (ADS) operation, and/or lane departure warning (LDW), among other examples. Systems that employ both radar and camera sensors can provide a high level of active safety capability and are increasingly available on production vehicles.

### SUMMARY

Some aspects described herein relate to a device. The device may include one or more sensors configured to monitor a driver control region of a vehicle, one or more memories, and one or more processors coupled to the one or more memories. The one or more processors may be configured to obtain, via the one or more sensors, sensor data associated with the driver control region of the vehicle, wherein the driver control region includes at least one of an accelerator component or a braking component associated with the vehicle. The one or more processors may be configured to detect, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The one or more processors may be configured to estimate, based on the one or more sensor detections, a driver reaction time associated with the driver of the vehicle. The one or more processors may be configured to provide, to a driving automation system, one or more recommendations based on at least one of the driver reaction time or the one or more sensor detections.

Some aspects described herein relate to a device. The device may include one or more memories and one or more processors coupled to the one or more memories. The one or more processors may be configured to obtain sensor data associated with a driver control region of a vehicle. The one or more processors may be configured to detect, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The one or more processors may be configured to determine, based on the one or more sensor detections, one or more reaction time risk indicators. The one or more processors may be configured to estimate, based on the one or more reaction time risk indicators, a driver reaction time associated with the driver of the vehicle. The one or more processors may be configured to perform one or more actions based on at least one of the driver reaction time or the one or more reaction time risk indicators.

Some aspects described herein relate to a method. The method may include obtaining, by a device and via one or more sensors, sensor data associated with the driver control region of the vehicle, wherein the driver control region includes at least one of an accelerator component or a braking component associated with the vehicle. The method may include detecting, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The method may include estimating, based on the one or more sensor detections, a driver reaction time associated with the driver of the vehicle. The method may include providing, by the device and to a driving automation system, one or more recommendations based on at least one of the driver reaction time or the one or more sensor detections.

Some aspects described herein relate to a method. The method may include obtaining, by a device, sensor data associated with a driver control region of a vehicle. The method may include detecting, by the device and based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The method may include determining, by the device and based on the one or more sensor detections, one or more reaction time risk indicators. The method may include estimating, by the device and based on the one or more reaction time risk indicators, a driver reaction time associated with the driver of the vehicle. The method may include performing, by the device, one or more actions based on at least one of the driver reaction time or the one or more reaction time risk indicators.

Some aspects described herein relate to a non-transitory computer-readable medium that stores a set of instructions. The set of instructions, when executed by one or more processors of a device, may cause the device to obtain sensor data associated with a driver control region of a vehicle, wherein the driver control region includes at least one of an accelerator component or a braking component associated with the vehicle. The set of instructions, when executed by one or more processors of the device, may cause the device to detect, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The set of instructions, when executed by one or more processors of the device, may cause the device to estimate, based on the one or more sensor detections, a driver reaction time associated with the driver of the vehicle. The set of instructions, when executed by one or more processors of the device, may cause the device to provide, to a driving automation system, one or more recommendations based on at least one of the driver reaction time or the one or more sensor detections.

Some aspects described herein relate to a non-transitory computer-readable medium that stores a set of instructions. The set of instructions, when executed by one or more processors of a device, may cause the device to obtain sensor data associated with a driver control region of a vehicle. The set of instructions, when executed by one or more processors of the device, may cause the device to detect, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The set of instructions, when executed by one or more processors of the device, may cause the device to determine, based on the one or more sensor detections, one or more reaction time risk indicators. The set of instructions, when executed by one or more processors of the device, may cause the device to estimate, based on the one or more reaction time risk indicators, a driver reaction time associated with the driver of the vehicle. The set of instructions, when executed by one or more processors of the device, may cause the device to perform one or more actions based on at least one of the driver reaction time or the one or more reaction time risk indicators.

Some aspects described herein relate to an apparatus. The apparatus may include means for obtaining sensor data associated with a driver control region of a vehicle. The apparatus may include means for detecting, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The apparatus may include means for determining, based on the one or more sensor detections, one or more reaction time risk indicators. The apparatus may include means for estimating, based on the one or more reaction time risk indicators, a driver reaction time associated with the driver of the vehicle. The apparatus may include means for performing one or more actions based on at least one of the driver reaction time or the one or more reaction time risk indicators.

Some aspects described herein relate to an apparatus. The apparatus may include means for obtaining, via one or more sensors, sensor data associated with the driver control region of the vehicle, wherein the driver control region includes at least one of an accelerator component or a braking component associated with the vehicle. The apparatus may include means for detecting, based on the sensor data, one or more sensor detections associated with one or more lower extremities of a driver of the vehicle, wherein the one or more sensor detections include at least one of a presence of a foreign object in the driver control region, a presence of the one or more lower extremities, or a posture of the one or more lower extremities. The apparatus may include means for estimating, based on the one or more sensor detections, a driver reaction time associated with the driver of the vehicle. The apparatus may include means for providing, to a driving automation system, one or more recommendations based on at least one of the driver reaction time or the one or more sensor detections.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented, in accordance with the present disclosure.

FIG. 2 is a diagram illustrating example components of a device, in accordance with the present disclosure.

FIGS. 3A-3C are diagrams of an example associated with driver assistance recommendations using sensor data associated with a lower extremity region, in accordance with the present disclosure.

FIG. 4 is a diagram of an example process associated with driver assistance recommendations using sensor data associated with a lower extremity region, in accordance with the present disclosure.

FIG. 5 is a flowchart of an example process associated with driver assistance recommendations using sensor data associated with a lower extremity region.

FIG. 6 is a flowchart of an example process associated with driver assistance recommendations using sensor data associated with a lower extremity region.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A vehicle may include a system (e.g., an electronic control unit (ECU), and/or an autonomous driving system) configured to control an operation of the vehicle. The system may use data obtained by one or more sensors of the vehicle to perform occupancy mapping to determine an occupancy status (e.g., unoccupied space, occupied space, and/or drivable space) of the environment surrounding the vehicle. For example, the system may use data obtained by a global navigation satellite system (GNSS)/inertial measurement unit (IMU), a camera, a light detection and ranging (LIDAR) scanner, and/or a radar scanner, among other examples, to determine an occupancy status of the environment surrounding the vehicle. The system may detect drivable space that the vehicle can occupy based on the occupancy status of the environment surrounding the vehicle. The system may be configured to identify, in real-time, the occupancy status of the environment surrounding the vehicle and to determine a drivable space that the vehicle is able to occupy based on the occupancy status of the environment. To perform occupancy and free space detection when using a sensor (e.g., a radar sensor, a LIDAR sensor, and/or a camera) configured to obtain point data of an object, the system may subdivide an area of interest (e.g., an area surrounding the vehicle) into a number of uniformly spaced square grids (e.g., occupancy grids).

In some examples, the system may be configured to perform one or more driving assistance operations based on an estimated driver reaction time (e.g., an estimated reaction time of the driver of the vehicle). For example, the one or more driving assistance operations may include adaptive cruise control (ACC), forward collision warning (FCW), collision mitigation or avoidance (e.g., via autonomous braking or autonomous acceleration), pre-crash functions (e.g., airbag arming or pre-activation), an advanced driver assistance system (ADAS) operation, an automated driving system (ADS) operation, and/or lane departure warning (LDW), among other examples. For example, vehicles may make use of radar and camera sensors for enhanced vehicle safety. One or more camera sensors mounted on a vehicle can be used to capture images of an environment surrounding the vehicle (e.g., in front of the vehicle, behind the vehicle, and/or to the sides of the vehicle). A processor within the vehicle (e.g., a digital signal processor (DSP) or other processor) can attempt to identify objects within the captured images. Such objects may be other vehicles, pedestrians, road signs, objects within the road of travel, and/or other types of objects. Radar systems may also be used to detect objects along the road of travel of the vehicle. For example, a radar system can include one or more sensors that utilize electromagnetic waves to determine information related to the objects, such as the location, range, altitude, direction, and/or speed of an object along the road.

As an example, the system may obtain sensor data associated with the vehicle's surroundings, such as the speeds and positions of other vehicles or pedestrians, road infrastructure, weather conditions, and/or road conditions, among other examples. The system may detect a trigger event based on the sensor data. For example, the system may identify potential hazards, such as a pedestrian crossing the road or a car suddenly braking ahead. In some examples, the system may predict future movements and/or positions of the potential hazards. The system may estimate a driver reaction time (e.g., an estimated amount of time for the driver to react to the detected potential hazard). The system may estimate the driver reaction time based on one or more factors, such as the vehicle's speed, a distance from the potential hazard, and/or the driver's previous behavior, among other examples. In some cases, to improve the estimation of the driver reaction time, the system may use driver monitoring as part of the estimation of the driver reaction time. For example, the system may monitor a gaze of the drive (e.g., using eye-tracking) and/or facial recognition to assess a level of alertness and/or attention of the driver. The level of alertness and/or attention of the driver may improve the estimation of the driver reaction time. If the system determines that the driver's estimated reaction time is insufficient to avoid the potential hazard (e.g., to avoid a collision), then the system may issue a warning to alert the driver, such as an audible or visual signal. In some cases, the system may also intervene directly, such as by braking the vehicle, accelerating the vehicle, and/or steering the vehicle to avoid the potential hazard.

However, in some cases, the estimated driver reaction time may be inaccurate. For example, the estimation of the driver reaction time may only consider factors associated with the vehicle, such as a speed of the vehicle, a distance from a potential hazard, and/or historical data of the driver (e.g., which may not necessarily be indicative of current behavior of the driver). In some cases, the system may use a gaze of the driver (e.g., using eye-tracking) and/or facial recognition to assess a level of alertness and/or attention of the driver by monitoring and/or sensing an upper portion of the driver's body. However, this data may not indicate information associated with parts of the driver's body that are actually used to control the vehicle. For example, a driver may control a speed of the vehicle using one or more lower extremities (e.g., a leg and/or foot of the driver), such as by interacting with a braking component (e.g., a brake pedal) and/or an accelerator component (sometimes referred to as an accelerator pedal or a gas pedal) using a foot of the driver. In some cases, a driver's lower extremities may be in a position or posture that results in additional movement to control the vehicle (e.g., the driver's legs may be crossed, such as in scenarios where cruise control is being used to control the speed of the vehicle). Additionally, or alternatively, there may be foreign objects around the lower extremities of the driver that increase an amount of time associated with the driver moving the driver's foot to the braking component or the accelerator component. Further, the different positions and/or postures of the lower extremities of the driver may require different recommendations and/or actions for the system (e.g., beyond simply estimating the driver reaction time). The inaccurate estimated driver reaction time may result in the system incorrectly performing one or more actions, thereby consuming processing resources, memory resources, and/or power resources associated with performing the one or more actions using an incorrect estimated driver reaction time. Further, the incorrect estimated driver reaction time may result in the system not performing an action and/or performing an action that may result in a collision of the vehicle.

Some aspects described herein enable driver assistance recommendations using sensor data associated with a lower extremity region. In some aspects, the system may use sensor data (e.g., camera data, radar data, and/or other sensor data) of a driver control region of the vehicle (e.g., an area of the vehicle in which controls, such as an accelerator component and a braking component associated with the vehicle, are located) to detect one or more reaction time risk indicators that may be associated with a modified driver reaction time. For example, the system may detect and/or determine a presence of a foreign object in the driver control region, a presence of the one or more lower extremities, and/or a posture of the one or more lower extremities that may be associated with a modified driver reaction time. The system may estimate a driver reaction time based on the one or more reaction time risk indicators. The system may generate one or more recommendations for a driving automation system of the vehicle based on the estimated driver reaction time and/or the one or more reaction time risk indicators. In some aspects, the system may perform, or may cause the driving automation system to perform, one or more actions based on the one or more recommendations.

For example, the system may detect that the lower extremities of the driver are in a dangerous position or posture (e.g., the legs of the driver may be crossed, such that a foot used to operate the accelerator pedal and/or the brake pedal is behind the other leg of the driver, resulting in additional time associated with the driver uncrossing the driver's legs before the foot of the driver can be used to operate the accelerator pedal and/or the brake pedal). As another example, the system may detect that the lower extremities of the driver are not present in the driver control region of the vehicle (e.g., may detect a lack of the presence of the one or more lower extremities). As another example, the system may detect a foreign object between the lower extremities of the driver and the accelerator pedal and/or the brake pedal of the vehicle. Such detections of position or posture (also referred to herein as a trigger posture) of the lower extremities of the driver may be used by the system to estimate the driver reaction time and/or to modify an estimated driver reaction time. Additionally, the dangerous position or posture may be used to generate one or more recommendations for the driving automation system of the vehicle.

As a result, the system is enabled to make improved estimations of the driver reaction time and/or improved recommendations for the driving automation system of the vehicle. Improving the estimations of the driver reaction time and/or the recommendations for the driving automation system may mitigate a risk of collisions for the vehicle and/or enhance safety of the vehicle by providing improved warnings and/or alerts to the driver and/or by enabling the driving automation system to perform improved collision mitigation or avoidance operations (e.g., autonomous braking or autonomous acceleration), and/or improved pre-crash functions (e.g., airbag arming or pre-activation), among other examples. Additionally, the improved estimations of the driver reaction time and/or the recommendations for the driving automation system conserve processing resources, memory resources, and/or network resources, among other examples, that would have otherwise been used performing operations (e.g., ACC operations, FCW operations, collision mitigation or avoidance operations, pre-crash operations (e.g., airbag arming or pre-activation), and/or LDW operations) based on inaccurate estimations of the driver reaction time.

In some aspects, the system may obtain an indication of an actual reaction time of the driver and store, in a reaction time database, an indication of the actual reaction time in connection with at least one of the one or more recommendations or the one or more sensor detections. The system may use information stored in the reaction time database to estimate the driver reaction time in different scenarios (e.g., when the driver's lower extremities are in different dangerous or trigger postures). In other words, a feedback loop may be used to improve the estimations of the driver reaction time in different scenarios associated with a position, presence, and/or posture of the lower extremities of a driver. In some aspects, the system may apply a scaling factor to modify an estimated driver reaction time (e.g., that is based on vehicle information and/or historical reaction times of the driver) based on detecting the one or more reaction time risk indicators. This may reduce a complexity associated with estimating the driver reaction time while also improving the estimation of the driver reaction time.

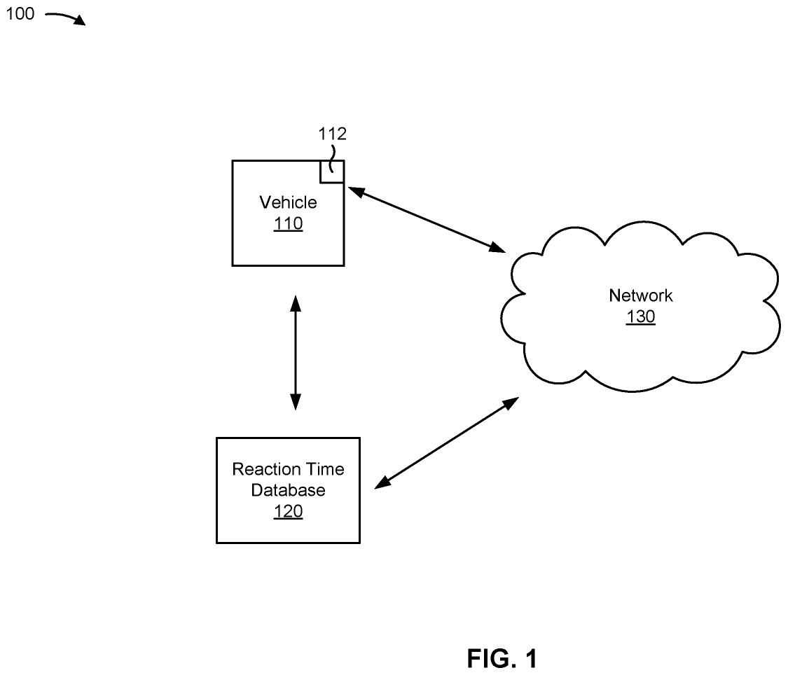

FIG. 1 is a diagram of an example environment 100 in which systems and/or methods described herein may be implemented, in accordance with the present disclosure. As shown in FIG. 1, environment 100 may include a vehicle 110 that includes an controller 112, a reaction time database 120, and a network 130. Devices of environment 100 may interconnect via wired connections, wireless connections, or a combination of wired and wireless connections.

The vehicle 110 may include any vehicle that is capable of transmitting and/or receiving data associated with processing for driver assistance recommendations using sensor data associated with a lower extremity region, as described herein. For example, the vehicle 110 may be a consumer vehicle, an industrial vehicle, and/or a commercial vehicle, among other examples. The vehicle 110 may be capable of traveling and/or providing transportation via public roadways, and/or may be capable of use in operations associated with a worksite (e.g., a construction site), among other examples. The vehicle 110 may include a sensor system that includes one or more sensors that are used to generate and/or provide vehicle data associated with vehicle 110 and/or a radar scanner and/or a LIDAR scanner that is used to obtain data associated with autonomous driving.

The vehicle 110 may be controlled by the controller 112, which may include one or more devices capable of receiving, generating, storing, processing, and/or providing information associated with driver assistance recommendations using sensor data associated with a lower extremity region described herein. In some aspects, the controller 112 may include an ECU. For example, the controller 112 may be associated with an autonomous driving system and/or may include and/or be a component of a communication and/or computing device, such as an onboard computer, a control console, an operator station, or a similar type of device. The controller 112 may be configured to communicate with an autonomous driving system (e.g., an advanced driver assistance system (ADAS) and/or an automated driving system (ADS)) of the vehicle 110, ECUs of other vehicles, and/or other devices. For example, advances in communication technologies have enabled vehicle-to-everything (V2X) communication, which may include vehicle-to-vehicle (V2V) communication, and/or vehicle-to-pedestrian (V2P) communication, among other examples. In some aspects, the controller 112 may receive vehicle data associated with the vehicle 110 (e.g., location information, sensor data, radar data, and/or LIDAR data) and perform sensing and/or measurements associated with a driver of the vehicle, as described herein.

The reaction time database 120 may include one or more devices capable of receiving, generating, storing, processing, and/or providing information associated with driver assistance recommendations using sensor data associated with a lower extremity region, as described elsewhere herein. The reaction time database 120 may include a communication device and/or a computing device. For example, the reaction time database 120 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the reaction time database 120 may store reaction times of one or more drivers and respective reaction time risk indicators and/or respective generated recommendations, as described elsewhere herein. In some examples, the reaction time database 120 may be associated with a particular driver (e.g., may store reaction times associated with the particular driver). In other examples, the reaction time database 120 may be associated with multiple drivers (e.g., may store reaction times associated with multiple drivers).

The network 130 includes one or more wired and/or wireless networks. For example, the network 130 may include a peer-to-peer (P2P) network, a cellular network (e.g., a long-term evolution (LTE) network, a code division multiple access (CDMA) network, an open radio access network (O-RAN), a New Radio (NR) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a cloud computing network, among other examples, and/or a combination of these or other types of networks. In some aspects, the network 130 may include and/or be a P2P communication link that is directly between one or more of the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

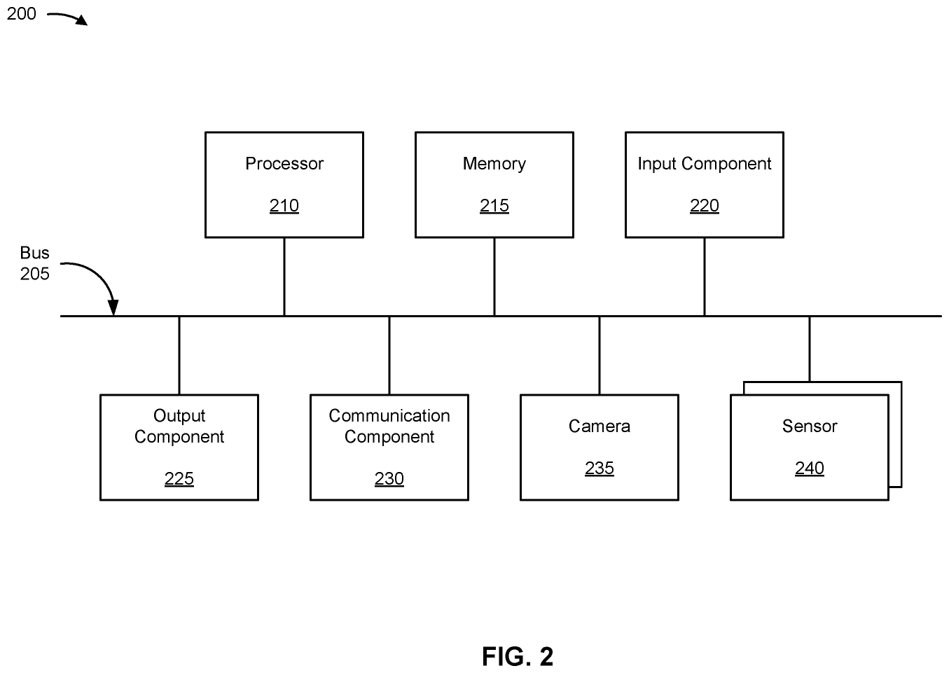

FIG. 2 is a diagram illustrating example components of a device 200, in accordance with the present disclosure. The device 200 may correspond to the vehicle 110, the controller 112, and/or the reaction time database 120. In some aspects, the vehicle 110, the controller 112, and/or the reaction time database 120 may include one or more devices 200 and/or one or more components of the device 200. As shown in FIG. 2, the device 200 may include a bus 205, a processor 210, a memory 215, an input component 220, an output component 225, a communication component 230, a camera 235, and/or one or more sensors 240.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, an antenna, an Ethernet interface, an optical interface, a coaxial interface, an infrared interface, a radio frequency interface, a universal serial bus (USB) interface, a wireless local area interface (e.g., a Wi-Fi interface), and/or a cellular network interface.

The camera 235 may include one or more devices capable of capturing images associated with the device 200. In some aspects, the camera 235 may include a low-resolution camera (e.g., a video graphics array (VGA)) that is capable of capturing images that are less than one megapixel or images that are less than 1216×912 pixels, a high-speed camera, an ADAS camera, a wide-angle lens camera, a digital camera, a single-lens reflex camera, a video camera, a dashboard camera (e.g., a dashcam), and/or a car digital video recorder, among other examples.

The one or more sensors 240 may include one or more devices capable of sensing characteristics associated with the device 200. A sensor 240 may include one or more integrated circuits (e.g., on a packaged silicon die) and/or one or more passive components of one or more flex circuits to enable communication with one or more components of the device 200. The sensor 240 may include an optical sensor that has a field of view in which the sensor 240 may determine one or more characteristics of an environment of the device 200. The sensor 240 may be a low-power device (e.g., a device that consumes less than ten milliwatts (mW) of power) that has always-on capability while the device 200 is powered on. Additionally, or alternatively, a sensor 240 may include magnetometer (e.g., a Hall effect sensor, an anisotropic magneto-resistive (AMR) sensor, and/or a giant magneto-resistive sensor (GMR)), a location sensor (e.g., a global positioning system (GPS) receiver and/or a local positioning system (LPS) device (e.g., that uses triangulation and/or multi-lateration)), a gyroscope (e.g., a micro-electro-mechanical systems (MEEMS) gyroscope or a similar type of device), an accelerometer, a speed sensor, a motion sensor, an infrared sensor, a temperature sensor, and/or a pressure sensor, among other examples.

The sensor 240 may include a radar scanner that may include one or more devices that use radio waves to determine the range, angle, and/or velocity of an object based on radar data obtained by the radar scanner. The radar scanner may provide the radar data to the controller 112 to enable the controller 112 to perform driver assistance recommendations using sensor data associated with a lower extremity region, as described herein. The radar scanner may include a radio frequency sensor (e.g., a millimeter wave sensor) that operates using signals included in a radio frequency spectrum (e.g., in the millimeter wave spectrum) to detect and/or measure objects, and/or an ultrasonic sensor (e.g., a sensor that uses sound waves with frequencies above the range of human hearing (typically above 20 kilohertz) to detect and measure objects), among other examples. The sensor 240 may include a LIDAR scanner. The LIDAR scanner may include one or more devices that use light in the form of a pulsed laser to measure distances of objects from the LIDAR scanner based on LIDAR data obtained by the LIDAR scanner. The LIDAR scanner may provide the LIDAR data to the controller 112 to enable the controller 112 to perform driver assistance recommendations using sensor data associated with a lower extremity region, as described herein.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for obtaining, by a device, sensor data associated with a driver control region of a vehicle; means for detecting, by the device and based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities; means for determining, by the device and based on the one or more sensor detections, one or more reaction time risk indicators; means for estimating, by the device and based on the one or more reaction time risk indicators, a driver reaction time associated with the driver of the vehicle; and/or means for performing, by the device, one or more actions based on at least one of the driver reaction time or the one or more reaction time risk indicators, among other examples. In some aspects, the means for device 200 to perform processes and/or operations described herein may include one or more components of device 200 described in connection with FIG. 2, such as bus 205, processor 210, memory 215, input component 220, output component 225, communication component 230, camera 235, and/or sensor(s) 240.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

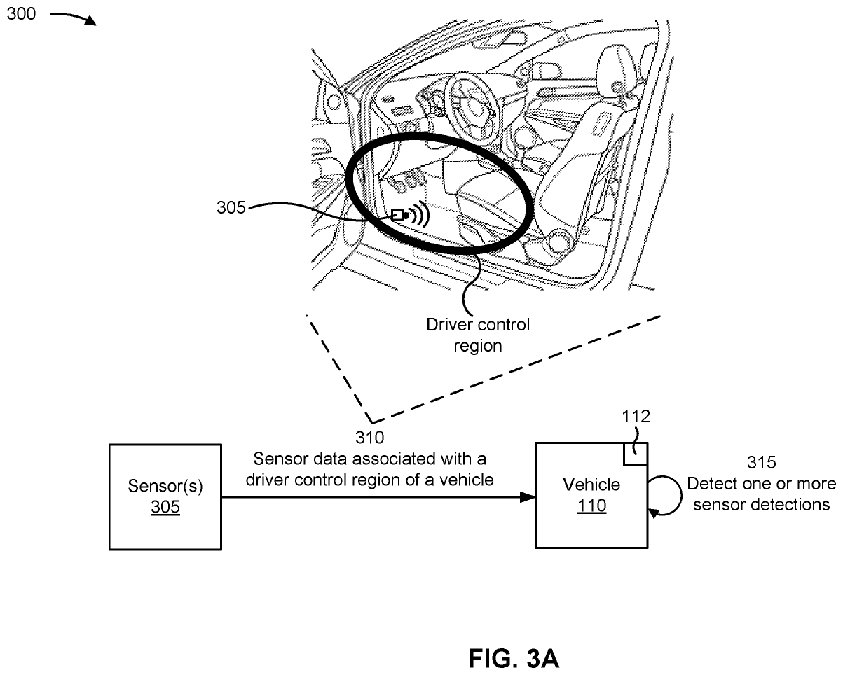

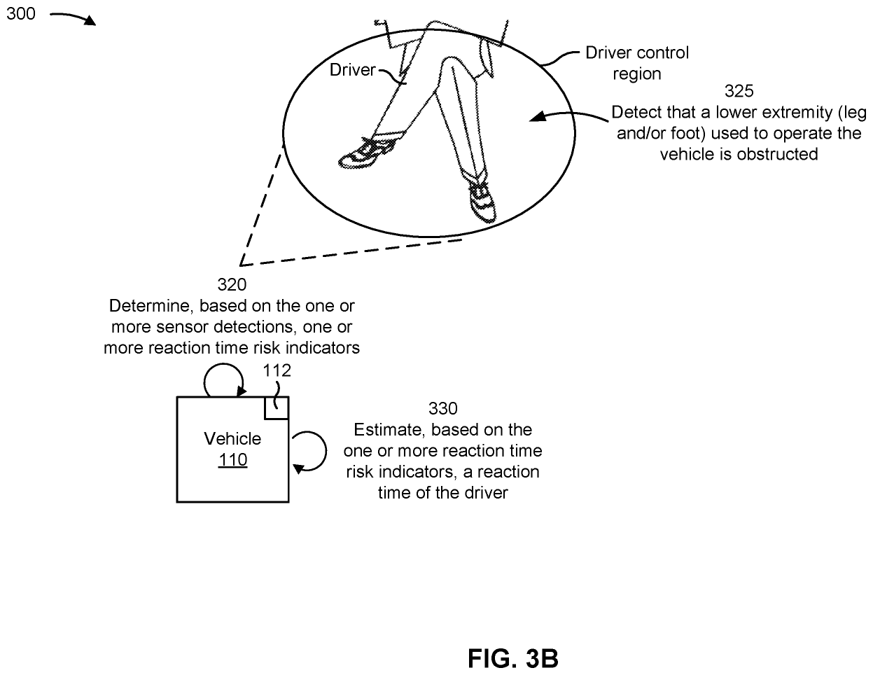

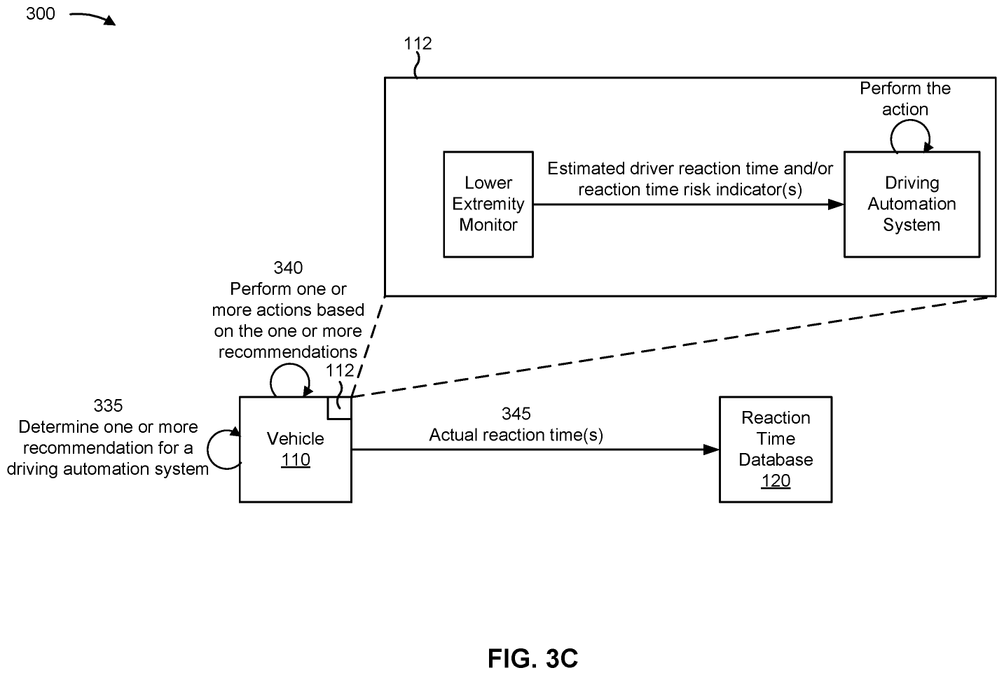

FIGS. 3A-3C are diagrams of an example 300 associated with driver assistance recommendations using sensor data associated with a lower extremity region, in accordance with the present disclosure. As shown in FIGS. 3A-3C, example 300 includes one or more sensors 305, the vehicle 110, the controller 112, and the reaction time database 120. The one or more sensors 305 may include one or more cameras 235, one or more sensors 240, and/or one or more other sensors. These devices are described in more detail below in connection with FIG. 1 and FIG. 2.

As shown in FIG. 3A, the one or more sensors 305 may be configured to monitor a driver control region of the vehicle 110. The driver control region may include a region of the vehicle associated with controls or components for controlling a speed or other aspects of the vehicle 110. For example, as shown in FIG. 3A, the driver control region may be located near the floor of a passenger compartment of the vehicle 110 in front of a seat in which the driver of the vehicle 110 sits. For example, the driver control region may include an accelerator component (e.g., an accelerator pedal and/or a gas pedal) and a braking component (e.g., a brake pedal) associated with the vehicle 110. In some aspects, the driver control region may include a component associated with operating a clutch of the vehicle 110 (e.g., a clutch pedal), such as when the vehicle 110 is associated with a manual transmission.

For example, the one or more sensors 305 may be configured to monitor an area in which one or more lower extremities of a driver of the vehicle 110 are typically located (e.g., when the driver is operating or driving the vehicle 110). For example, the driver of the vehicle may sit in a seat of the vehicle 110 and use a foot to operate an accelerator component (e.g., an accelerator pedal and/or a gas pedal) and a braking component (e.g., a brake pedal) associated with the vehicle 110. The driver control region depicted in FIG. 3A is provided as an example. In other examples, the driver control region may be differently configured (e.g., based on a configuration or design of the vehicle 110). In such examples, the one or more sensors 305 may be configured to monitor an area in which lower extremities of the driver are typically located to control or operate components of the vehicle 110.

As shown in FIG. 3A, and by reference number 310, the vehicle 110 and/or the controller 112 may obtain sensor data and/or point data collected by the one or more sensors 305. In some aspects, the sensor data may include one or more images captured by a camera. In some aspects, the sensor data may include video captured by a video camera. For example, the sensor data may include one or more image frames captured by one or more cameras.

The sensor data may indicate one or more sensor detections (e.g., one or more radar detections and/or one or more LIDAR detections). For example, the controller 112 may receive sensor data and/or point data from the one or more sensors 305. The sensor data may identify a plurality of points corresponding to one or more objects located in the driver control region of the vehicle 110. For example, a radar scanner may transmit one or more pulses of electromagnetic waves. The one or more pulses may be reflected by an object in a path of the one or more pulses. The reflection may be received by the radar scanner. The radar scanner may determine one or more characteristics (e.g., an amplitude, a frequency, and/or the like) associated with the reflected pulses and may determine point data indicating a location of the object based on the one or more characteristics. The radar scanner may provide the point data to the controller 112 indicating a radar detection.

Additionally, or alternatively, a LIDAR scanner may send out one or more pulses of light. The one or more pulses may be reflected by an object in a path of the one or more pulses. The reflection may be received by the LIDAR scanner. The LIDAR scanner may determine one or more characteristics associated with the reflected pulses and may determine point data indicating a location of the object based on the one or more characteristics. The LIDAR scanner may provide the point data to the controller 112 indicating a LIDAR detection.

In some examples, the sensor data may include a sensor image (or frame) that includes a plurality of points (e.g., a point cloud), with each point indicating a signal reflected from that point and measurements of that point. In some cases, the sensor image (or frame) may visually depict an intensity of electromagnetic reflections from objects in the driver control region. In some examples, the sensor image (or frame) may include a list of objects including attributes for each object, such as intensity, signal-to-noise ratio (SNR), length, width, and/or yaw, among other examples. In some examples, the sensor data may include multiple sensor images (or frames). In some examples, point cloud data may be a collection of individual points within the driver control region that identify a measured parameter of objects within the driver control region.

In some examples, the sensor data may include infrared data. For example, infrared sensing may be used to detect a body part (e.g., of a driver of the vehicle 110) by detecting thermal energy emitted by the body part. Infrared sensing may include detecting the radiation emitted by a body part in the infrared spectrum. Infrared sensors may contain a detector that is sensitive to this type of radiation. When a body part comes into the range of the infrared sensor, the detector detects the radiation emitted by the body part and converts it into an electrical signal. Infrared data may be useful for distinguishing between a body part and other objects (e.g., foreign objects) because human body parts will emit a higher level of radiation in the infrared spectrum than other objects.

As shown by reference number 315, the vehicle 110 and/or the controller 112 may detect one or more sensor detections based on the sensor data. For example, the vehicle 110 and/or the controller 112 may detect, based on the sensor data, one or more sensor detections associated with one or more lower extremities of a driver of the vehicle 110. In some aspects, the one or more sensor detections may include a presence of a foreign object in the driver control region, a size of a detected foreign object, a presence of one or more lower extremities of the driver (e.g., indicating whether the one or more lower extremities were detected in the driver control region), locations of any detected lower extremities of the driver, and/or postures of the one or more lower extremities, among other examples.

For example, the vehicle 110 and/or the controller 112 may use point data indicated by the one or more sensors 305 (e.g., radar data) and/or image(s) to detect whether any foreign objects are in the driver control region. As used herein, “foreign object” may refer to an object that is not associated with the vehicle (e.g., the accelerator pedal, the brake pedal, a clutch pedal, and/or a seat) or a lower extremity of the driver that is detected in the driver control region of the vehicle. In some aspects, the vehicle 110 and/or the controller 112 may determine a size of the foreign object. Additionally, or alternatively, the vehicle 110 and/or the controller 112 may determine, based on the sensor data, a location of the foreign object. For example, the vehicle 110 and/or the controller 112 may determine a location of the foreign object relative to control components (e.g., the accelerator pedal, the brake pedal, and/or the clutch pedal) of the vehicle 110 and any detected lower extremities of the driver (e.g., that are used to operate the control components).

In some aspects, the vehicle 110 and/or the controller 112 may categorize any detected foreign objects. For example, the vehicle 110 and/or the controller 112 may use a computer vision technique or model to identify a type or category associated with the foreign object. For example, the vehicle 110 and/or the controller 112 may perform feature extraction to identify key characteristics of the foreign object in the image, such as edges, corners, and texture patterns. The vehicle 110 and/or the controller 112 may represent the features as numerical values or vectors. The vehicle 110 and/or the controller 112 may compare the extracted features with a set of pre-defined models or templates. The models may be created using machine learning techniques and may represent different object classes or categories of objects. The vehicle 110 and/or the controller 112 may assign a likelihood score to each model based on how well the extracted features match the template features. The vehicle 110 and/or the controller 112 may select the model with the highest likelihood score as the predicted object class for the detected foreign object.

Determining the category of a foreign object may assist the vehicle 110 and/or the controller 112 in determining whether the foreign object presents a risk of increased reaction time on the part of the driver, as described in more detail elsewhere herein. For example, some categories of foreign objects, such as a pen, a cellphone, or similar categories of objects, may be small and/or easily avoided by the driver when operating the vehicle using the driver's lower extremities (e.g., thereby indicating a low risk of increased reaction time on the part of the driver). Other categories of foreign objects, such as a bag, a mug, cans, a bottle, a ball, a backpack, or similar categories of objects, may be larger and/or may represent obstacles or obstructions for the driver when operating the vehicle using their lower extremities (e.g., thereby indicating a high risk of increased reaction time on the part of the driver). For example, a round object (e.g., a can, a bottle, and/or a ball) may present a risk of rolling in the driver control region and blocking a pedal or other control component. As another example, some categories of objects may be associated with a high likelihood of being placed in the driver control region by the driver intentionally, thereby indicating that the driver is aware of the presence of the foreign object (e.g., thereby indicating a low risk of increased reaction time on the part of the driver).

In some aspects, the vehicle 110 and/or the controller 112 may determine, based on the sensor data, whether one or more lower extremities (e.g., legs and/or feet) of the driver were detected in the driver control region. For example, the vehicle 110 and/or the controller 112 may analyze radar detections and/or image(s) captured by the one or more sensors 305 to determine whether the radar detections and/or image(s) indicate a presence of the one or more lower extremities.

In some aspects, the vehicle 110 and/or the controller 112 may estimate a posture of the one or more lower extremities (e.g., if detected via the sensor data) based on the sensor data. For example, a posture estimator may be a computer vision system that utilizes image or video data to estimate the pose or position of an object or human body. In the context of human posture estimation, the vehicle 110 and/or the controller 112 may estimate the position and orientation of a person's body parts relative to each other. For example, the vehicle 110 and/or the controller 112 may use a neural network (e.g., a convolutional neural network (CNN)) to estimate the posture of the one or more lower extremities. The CNN may be trained on a large dataset of labeled images or videos of people in different postures, which enables the CNN to learn to recognize and classify various body parts and their orientations. The input to the posture estimator (e.g., the CNN) may include the sensor data. For example, the input may include one or more frames from a video stream or a single image.

The output of the posture estimator (e.g., the CNN) may be a set of 2D or 3D joint positions and orientations. The joints can be represented as key points on the lower extremities of the body of the driver, such as the knees and/or the ankles. The output may also include additional information, such as the confidence or likelihood of the estimated poses or postures. For example, a posture of the lower extremities of the body of the driver may include a straight-legged posture (e.g., associated with the legs of the driver being side-by-side and not crossed), a crossed-legged posture (e.g., associated with one leg of the driver being placed over the other), and/or a crossed-foot posture (e.g., associated with one foot of the driver being placed over the other), among other examples.

As shown in FIG. 3B, and by reference number 320, the vehicle 110 and/or the controller 112 may determine, based on the one or more sensor detections, one or more reaction time risk indicators. As used herein, a “reaction time risk indicator” may be a detection or determination (e.g., made by the vehicle 110 and/or the controller 112) that indicates a modification (or increase) of a reaction time of the driver. For example, a reaction time risk indicator, if detected, may indicate that operating the vehicle 110 via a lower extremity of the driver (e.g., with a foot of the driver) may be associated with more time than if the reaction time risk indicator were not detected. In other words, a reaction time risk indicator may be associated with an obstacle, obstruction, and/or an event that is associated with some amount of time needed by the driver to navigate before operating the vehicle 110 via a lower extremity of the driver (e.g., in addition to a typical reaction time of the driver). For example, the driver may react to a potential hazard (e.g., after a reaction time) and then may navigate the obstacle, obstruction, or other event (e.g., associated with the one or more reaction time risk indicators) before operating the vehicle 110 via a lower extremity of the driver.

For example, the vehicle 110 and/or the controller 112 may determine a reaction time risk indicator based on detecting the presence of a foreign object in the driver control region. In some aspects, the vehicle 110 and/or the controller 112 may determine a reaction time risk indicator based on a size and/or location of a detected foreign object in the driver control region. For example, the vehicle 110 and/or the controller 112 may determine a reaction time risk indicator based on a position of a foreign object relative to a location of one or more lower extremities of the driver and control components (e.g., the accelerator pedal, the brake pedal, and/or the clutch pedal) of the vehicle 110. For example, if the foreign object is detected between the one or more lower extremities of the driver and control components, then the vehicle 110 and/or the controller 112 may determine a reaction time risk indicator (e.g., because the foreign object presents an obstruction for the driver to navigate when moving a lower extremity to the control component(s) to operate the vehicle 110). As another example, if the foreign object is detected behind the lower extremities of the driver (e.g., and not between the lower extremities of the driver and control components), then the vehicle 110 and/or the controller 112 may determine that the presence of the foreign object is not a reaction time risk indicator (e.g., because the foreign object does not present an obstruction for the driver to navigate when moving a lower extremity to the control component(s) to operate the vehicle 110).

In some aspects, the vehicle 110 and/or the controller 112 may determine a reaction time risk indicator based on a size of the detected foreign object satisfying a size threshold (e.g., a height satisfying a height threshold and/or a width satisfying a width threshold). For example, smaller objects may be associated with no, or lower, risk of increased reaction time for the driver. Therefore, the vehicle 110 and/or the controller 112 may determine a reaction time risk indicator (or a level of risk of increased reaction time) based on a size of the detected foreign object.

In some aspects, the vehicle 110 and/or the controller 112 may determine a reaction time risk indicator based on a category or type associated with a detected foreign object. For example, the vehicle 110 and/or the controller 112 may store one or more categories of objects that are associated with reaction time risk indicators. The vehicle 110 and/or the controller 112 may determine whether a category or type associated with a detected foreign object is included in the one or more categories of objects that are associated with reaction time risk indicators. For example, a pen may not be associated with a reaction time risk indicator, whereas a backpack may be associated with a reaction time risk indicator.

In some aspects, the vehicle 110 and/or the controller 112 may determine a reaction time risk indicator based on a risk score associated with a detected foreign object. The risk score may indicate a level of risk that the foreign object may increase an amount of time needed for the driver to move a lower extremity to a control component of the vehicle 110 to operate the control component. The risk score may be based on a type or category associated with the foreign object, a size of the foreign object, a position of the foreign object relative to the one or more lower extremities, and/or a position of the foreign object relative to at least one of the accelerator component or the braking component. For example, if the foreign object has a larger size, then the risk score may be higher. As another example, if the foreign object is located between a lower extremity of the driver and a control component, then the risk score may be higher. In some aspects, a higher risk score may result in the vehicle 110 and/or the controller 112 estimating a longer reaction time for the driver of the vehicle 110.

In some aspects, the vehicle 110 and/or the controller 112 may determine a reaction time risk indicator based on a presence of one or more lower extremities of the driver in the driver control region of the vehicle 110. For example, the vehicle 110 and/or the controller 112 may determine whether one or more lower extremities of the driver were detected in the driver control region of the vehicle 110. If the vehicle 110 and/or the controller 112 determines that no lower extremities of the driver were detected in the driver control region of the vehicle 110 (e.g., a lack of the presence of the one or more lower extremities), then the vehicle 110 and/or the controller 112 may determine a reaction time risk indicator. For example, a lower extremity (e.g., a foot) of the driver may be used to operate control components of the vehicle 110. Therefore, if no lower extremities of the driver are detected (or if the lower extremity used by the driver to operate the vehicle 110 is not detected) in the driver control region of the vehicle 110, then there may be an amount of time associated with the driver moving a lower extremity into the driver control region to operate the vehicle 110 in addition to a normal reaction time of the driver (e.g., resulting in an increased amount of time associated with the driver reacting to a potential hazard).

In some aspects, the vehicle 110 and/or the controller 112 may determine or identify which and/or a quantity of lower extremities that are used by the driver to operate the vehicle 110. For example, some drivers may be missing a lower extremity (e.g., a leg and/or foot). In such examples, the vehicle 110 and/or the controller 112 may be configured to determine that a reaction time risk indicator is not present if the lower extremity (e.g., a leg and/or foot) is not detected in the driver control region.

In some aspects, the vehicle 110 and/or the controller 112 may determine a reaction time risk indicator based on a posture of one or more lower extremities of the driver in the driver control region of the vehicle 110. For example, the vehicle 110 and/or the controller 112 may detect that the one or more lower extremities of the driver are in a trigger posture or a dangerous posture. In some aspects, the vehicle 110 and/or the controller 112 may store an indication of one or more trigger postures or dangerous postures. The vehicle 110 and/or the controller 112 may estimate a posture of the one or more lower extremities of the driver (e.g., as described in more detail above), and may determine that the posture is a trigger posture (e.g., based on comparing the posture to the one or more trigger postures or dangerous postures). For example, a trigger posture or a dangerous posture may be associated with some amount of time needed for the driver to move a foot or other extremity before the driver can use the foot or other lower extremity to operate a control component (e.g., an accelerator pedal or a brake pedal) of the vehicle 110.

For example, as shown by reference number 325, the vehicle 110 and/or the controller 112 may detect that a lower extremity (e.g., a leg and/or foot) of the driver that is used to operate the vehicle 110 is obstructed because of the posture of the one or more lower extremities. For example, the vehicle 110 and/or the controller 112 may determine that a foot of the driver that is used to operate an accelerator component or a brake component of the vehicle 110 by the driver is obstructed by another extremity included in the one or more lower extremities or by the foreign object relative to the accelerator component or the brake component. The vehicle 110 and/or the controller 112 may determine a reaction time risk indicator based on detecting that the lower extremity of the driver is obstructed. For example, as shown in FIG. 3B, the posture may be a crossed-leg posture (e.g., with one leg of the driver placed in front of the other). For example, the driver may cross the driver's legs when a speed of the vehicle 110 is being controlled by the controller 112 or another system of the vehicle (e.g., by a cruise control function of the vehicle 110). In such scenarios, an amount of time associated with the driver operating the vehicle (e.g., operating a control component in the driver control region) may be associated with an increased amount of time above the actual reaction time of the driver. For example, the driver may need to react to a potential hazard (e.g., associated with the actual reaction time) and then uncross the legs of the driver (e.g., associated with some additional time) before the driver can use a lower extremity to operate the vehicle 110. Other postures of the lower extremities may similarly be associated with a reaction time risk indicator, such as a crossed-foot posture (or crossed-ankles posture), a knees-apart posture, or a figure-four posture (e.g., associated with the legs crossed and one ankle over another knee), among other examples.

In some aspects, the vehicle 110 and/or the controller 112 may determine a reaction time risk indicator based on a location of a lower extremity (e.g., a leg and/or foot) of the driver that is used to operate the vehicle 110. For example, the vehicle 110 and/or the controller 112 may determine a location of a lower extremity (e.g., a foot) of the driver that is used to operate the vehicle relative to the control component(s) (e.g., the accelerator pedal and/or the brake pedal) in the driver control region. For example, the vehicle 110 and/or the controller 112 may determine a distance between the lower extremity and the control component(s). If the distance satisfies a distance threshold, then the vehicle 110 and/or the controller 112 may determine that a reaction time risk indicator is present. In some aspects, the vehicle 110 and/or the controller 112 may determine a level of risk (e.g., of increased reaction time of the driver) based on the distance (e.g., a larger distance may indicate a greater risk).

As shown by reference number 330, the vehicle 110 and/or the controller 112 may estimate, based on the one or more reaction time risk indicators, a reaction time of the driver (also referred to herein as a driver reaction time). For example, the reaction time of the driver may include an actual reaction time of the driver and an amount of time associated with the driver navigating or dealing with objects or obstacles (e.g., a foreign object, a location of one or more lower extremities, and/or a posture of the one or more lower extremities) associated with the one or more reaction time risk indicators. For example, the vehicle 110 and/or the controller 112 may estimate, based on the one or more sensor detections and/or the one or more reaction time risk indicators, a reaction time associated with the driver of the vehicle 110.

For example, the vehicle 110 and/or the controller 112 may estimate the reaction time of the driver based on vehicle information (e.g., a speed of the vehicle 110, a distance to a potential hazard from the vehicle 110, road conditions, weather conditions, or other factors), upper body information of the driver (e.g., a gaze, eye position, eye movement, and/or upper body posture), historical behavior of the driver, and/or on the one or more sensor detections and/or the one or more reaction time risk indicators. This provides a more accurate estimation of the time associated with the drive reacting to a potential hazard because the estimated reaction time of the driver accounts for an amount of time associated with the driver moving and/or navigating a lower extremity to interact with a control component (e.g., an accelerator pedal or a brake pedal) to control the vehicle 110.

In some aspects, the vehicle 110 and/or the controller 112 may estimate the reaction time of the driver based on vehicle information (e.g., a speed of the vehicle 110, a distance to a potential hazard from the vehicle 110, road conditions, weather conditions, or other factors), upper body information of the driver (e.g., a gaze, eye position, eye movement, and/or upper body posture), and/or the historical behavior of the driver, among other examples, to obtain an estimated driver reaction time. The vehicle 110 and/or the controller 112 may modify the estimated driver reaction time based on detecting the one or more sensor detections and/or the one or more reaction time risk indicators. For example, the vehicle 110 and/or the controller 112 may increase or decrease the estimated driver reaction time based on detecting the one or more sensor detections and/or the one or more reaction time risk indicators.

As an example, the vehicle 110 and/or the controller 112 may apply a scaling factor to the estimated driver reaction time based on detecting the one or more sensor detections and/or the one or more reaction time risk indicators. A value of the scaling factor may be based on the one or more sensor detections and/or the one or more reaction time risk indicators. For example, if the vehicle 110 and/or the controller 112 detects a foreign object, then the vehicle 110 and/or the controller 112 may apply a first scaling factor to the estimated driver reaction time (e.g., where a value of the first scaling factor is based on a size, position, and/or category of the foreign object). If the vehicle 110 and/or the controller 112 detects that the lower extremities of the driver are in a dangerous posture or a trigger posture, then the vehicle 110 and/or the controller 112 may apply a second scaling factor to the estimated driver reaction time (e.g., where a value of the second scaling factor is based on the particular posture of the lower extremities). If the vehicle 110 and/or the controller 112 detects that the lower extremities of the driver are not detected in the driver control region of the vehicle 110, then the vehicle 110 and/or the controller 112 may apply a third scaling factor to the estimated driver reaction time. In some aspects, a value of the scaling factor applied by the vehicle 110 and/or the controller 112 may be based on a combination of sensor detections and/or reaction time risk indicators (e.g., the vehicle 110 and/or the controller 112 may apply a combination of, or summation of, scaling factors based on the detected sensor detections and/or reaction time risk indicators).

In some aspects, the vehicle 110 and/or the controller 112 may increase the estimated reaction time, such as when additional time will be associated with the driver moving and/or navigating a lower extremity to interact with a control component (e.g., an accelerator pedal or a brake pedal) to control the vehicle 110. In other aspects, the vehicle 110 and/or the controller 112 may decrease the estimated reaction time, such as when the posture and/or position of the lower extremities indicates that a lower extremity of the driver is close to the control components of the vehicle 110.

In some aspects, the vehicle 110 and/or the controller 112 may use information from the reaction time database 120 to estimate the reaction time of the driver. For example, the reaction time database 120 may store reactions times associated with respective sensor detections and/or respective reaction time risk indicators. For example, the reaction time database 120 may store an indication of one or more reaction times associated with a given posture of lower extremities of the driver, and/or one or more reaction times associated with a given category of detected foreign object, among other examples. The reaction times stored in the reaction time database 120 may be associated with multiple drivers (e.g., may be collected and/or determined from data associated with multiple drivers). In other examples, the reaction times stored in the reaction time database 120 may be associated with the driver of the vehicle 110 (e.g., may be historical reaction times of the driver of the vehicle 110).

As shown in FIG. 3C, and by reference number 335, the vehicle 110 and/or the controller 112 may determine one or more recommendations for a driving automation system of the vehicle 110 (e.g., an ADAS or an ADS of the vehicle 110). For example, the vehicle 110 and/or the controller 112 may determine the one or more recommendations based on the estimated reaction time, the one or more sensor detections, and/or the one or more reaction time risk indicators. In some aspects, the one or more recommendations may include to adjust a speed of the vehicle 110, to display or output a warning message to the driver, to adjust one or more parameters of the driving automation system (e.g., to adjust a driving style, to adjust a minimum distance between the vehicle 110 and another vehicle, or to adjust another parameter of the driving automation system), and/or to cause the vehicle 110 to safely stop operations (e.g., to cause the vehicle to pull over to the side of a road and to stop the vehicle 110), among other examples.

For example, if the vehicle 110 and/or the controller 112 detects that the posture of the one or more lower extremities of the driver is a trigger posture or a dangerous posture, then the vehicle 110 and/or the controller 112 may determine that the one or more recommendations include to reduce a speed of the vehicle 110, display or output a warning message to the driver (e.g., indicating or requesting that the driver change the posture of the lower extremities), to increase a minimum distance between the vehicle 110 and another vehicle, and/or to cause the vehicle 110 to safely stop operations (e.g., if the posture of the lower extremities is not changed after some amount of time), among other examples. As another example, if the vehicle 110 and/or the controller 112 detects that no lower extremities of the driver are present in the driver control region, then the vehicle 110 and/or the controller 112 may determine that the one or more recommendations include to display or output a warning message to the driver (e.g., indicating or requesting that the driver return the lower extremities to the driver control region) and to cause the vehicle 110 to safely stop operations (e.g., if the lower extremities are not detected in the driver control region for some amount of time after outputting the warning), among other examples.

In some aspects, as shown in FIG. 3C, the controller 112 may include a lower extremity monitor that performs one or more (or all) of the operations described above, such as detecting the one or more sensor detections and/or the one or more reaction time risk indicators. In some aspects, the lower extremity monitor may provide, and the driving automation system may obtain, an indication of the estimated driver reaction time and/or an indication of the one or more reaction time risk indicators. Additionally, or alternatively, the lower extremity monitor may provide, and the driving automation system may obtain, an indication of the one or more recommendations.

The driving automation system may use the estimated driver reaction time and/or the one or more reaction time risk indicators to determine one or more actions to be performed. For example, the driving automation system may use the estimated driver reaction time and/or the one or more reaction time risk indicators to determine to perform one or more actions as indicated by the one or more recommendations.

The vehicle 110 and/or the controller 112 may provide information (e.g., an estimated driver reaction time, recommendations, and/or indications of reaction time risk indicators) to the driving automation system in accordance with a periodic schedule and/or based on detecting a trigger event. The trigger event may be associated with determining the one or more reaction time risk indicators. For example, if the vehicle 110 and/or the controller 112 detects a reaction time risk indicator, then the vehicle 110 and/or the controller 112 may provide information to the driving automation system, in a similar manner as described elsewhere herein. In other words, the vehicle 110 and/or the controller 112 may provide information to the driving automation system periodically and/or in an event-based manner.

In some aspects, the vehicle 110 and/or the controller 112 (and/or the driving automation system) may determine a driver safety score associated with the driver based on the one or more reaction time risk indicators. The driver safety score may be a measurement of how safely the driver operates a vehicle. For example, driver safety scores may be used by fleet managers, insurance companies, and/or other organizations to assess the driving behavior of individual drivers or entire fleets. By monitoring and analyzing driving behavior, these organizations can identify unsafe driving practices and take corrective action to improve driver safety. For example, the vehicle 110 and/or the controller 112 (and/or the driving automation system) may determine or calculate a lower driver safety score based on detecting that the driver is operating the vehicle while the driver's lower extremities are in a dangerous posture, as described in more detail elsewhere herein. This may improve the accuracy of the driver safety score for the driver.

As shown by reference number 340, the vehicle 110 and/or the controller 112 (and/or the driving automation system) may perform one or more actions. The one or more actions may be based on the one or more recommendations, the estimated driver reaction time, and/or the one or more reaction time risk indicators. For example, the one or more actions may include adjusting a speed of the vehicle 110, displaying or outputting a warning message, adjusting one or more parameters of the driving automation system, and/or causing the vehicle 110 to safely stop operations, among other examples. In some aspects, the one or more actions may include ACC operations, FCW operations, collision mitigation or avoidance operations, pre-crash operations (e.g., airbag arming or pre-activation), and/or LDW operations, among other examples.

For example, if a reaction time risk indicator is associated with no lower extremities of the driver being included in the driver control region, then the one or more actions may include displaying or outputting (e.g., via a display screen or an audio output component) a warning message requesting the driver to return the one or more lower extremities to the driver control region. The vehicle 110 and/or the controller 112 may continue to monitor the driver control region (e.g., via the one or more sensors 305) in a similar manner as described elsewhere herein, such as in connection with FIG. 3A. The vehicle 110 and/or the controller 112 may detect that an amount of time from a time at which the warning message is output or displayed satisfies a time threshold. If no extremities of the driver are detected in the control region during the amount of time, then the one or more actions may include causing the vehicle 110 to safely stop movement (e.g., causing the vehicle 110 to pull over to a side of the road and stop movement or park).

As shown by reference number 345, the vehicle 110 and/or the controller 112 may provide, to the reaction time database, one or more actual reaction times (e.g., measured reaction times) of the driver of the vehicle 110. For example, the vehicle 110 and/or the controller 112 may determine an amount of time associated with the driver providing an input to a control component of the vehicle 110 (e.g., pressing the accelerator pedal or the brake pedal) in scenarios described above (e.g., in the presence of a foreign object in the driver control region and/or when the driver's lower extremities are in a given posture). The vehicle 110 and/or the controller 112 may store, in the reaction time database 120, the one or more actual reaction times in association with respective recommendations and/or respective reaction time risk indicators associated with the one or more reaction times. In other words, the vehicle 110 and/or the controller 112 may store, in the reaction time database 120, an actual reaction time of the driver and the recommendations that were generated and/or reaction time risk indicators that were detected in a scenario or situation associated with the actual reaction time. In some aspects, the vehicle 110 and/or the controller 112 may store, in the reaction time database 120, an actual reaction time of the driver even if no recommendations are generated.

As described elsewhere herein, the vehicle 110 and/or the controller 112 may estimate the driver reaction time based on the one or more sensor detections and data stored in the reaction time database 120. For example, a feedback loop may be used by the vehicle 110 and/or the controller 112 (e.g., using the feedback of the actual reaction times of the driver and/or other drivers in similar situations) to improve the estimations of the driver reaction time based on data (e.g., the presence and/or posture) of lower extremities of the driver.

As a result, the vehicle 110 and/or the controller 112 may be enabled to make improved estimations of the driver reaction time and/or improved recommendations for the driving automation system of the vehicle. Improving the estimations of the driver reaction time and/or the recommendations for the driving automation system may mitigate a risk of collisions for the vehicle and/or enhance safety of the vehicle by providing improved warnings and/or alerts to the driver and/or by enabling the driving automation system to perform improved collision mitigation or avoidance operations (e.g., autonomous braking or autonomous acceleration), and/or improved pre-crash functions (e.g., airbag arming or pre-activation), among other examples. Additionally, the improved estimations of the driver reaction time and/or the recommendations for the driving automation system conserve processing resources, memory resources, and/or network resources, among other examples, that would have otherwise been used performing operations (e.g., ACC operations, FCW operations, collision mitigation or avoidance operations, pre-crash operations (e.g., airbag arming or pre-activation), and/or LDW operations) based on inaccurate estimations of the driver reaction time.

As indicated above, FIGS. 3A-3C are provided as examples. Other examples may differ from what is described with regard to FIGS. 3A-3C.

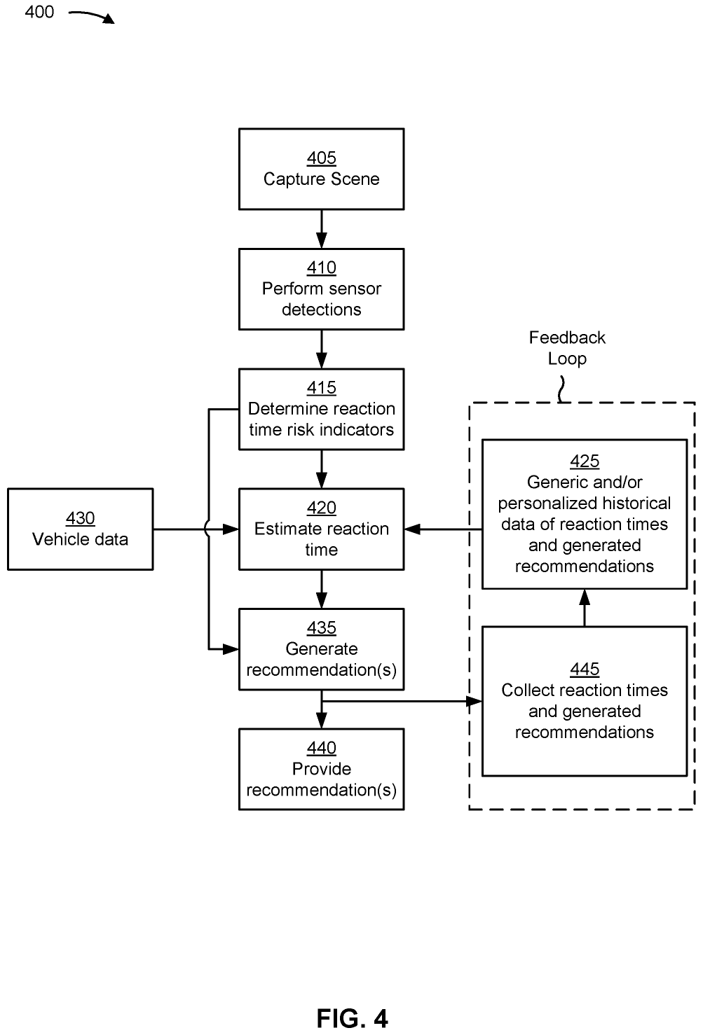

FIG. 4 is a diagram of an example process 400 associated with driver assistance recommendations using sensor data associated with a lower extremity region, in accordance with the present disclosure. The operations shown in process 400 may be performed by the vehicle 110, the controller 112, and/or a driving automation system of the vehicle 110, among other examples.

As shown by reference number 405, the process 400 may be associated with capturing a scene. The scene may include the driver control region of the vehicle 110. For example, the one or more sensors may capture sensor data indicating or depicting the scene, as described elsewhere herein. As shown by reference number 410, the process 400 may include performing sensor detections. For example, the process 400 may include detecting a presence of foreign objects and/or lower extremities of the driver in the driver control region of the vehicle 110. Additionally, or alternatively, the process 400 may include detecting a posture of the lower extremities of the driver.

As shown by reference number 415, the process 400 may include determining one or more reaction time risk indicators. For example, the one or more reaction time risk indicators may include an estimation of a foreign object risk (e.g., based on a size of the foreign object, a location of the foreign object, and/or a category or type associated with the foreign object). Additionally, or alternatively, process 400 may include determining whether any lower extremities of the driver are present in the driver control region of the vehicle 110 (e.g., a reaction time risk indicator may be associated with no lower extremities of the driver being present or detected in the driver control region). Additionally, or alternatively, process 400 may include determining whether a posture of the lower extremities of the driver is a dangerous posture or a trigger posture. For example, one or more reaction time risk indicators may be associated with the posture of the lower extremities of the driver being a dangerous posture or a trigger posture. The one or more reaction time risk indicators are described in more detail elsewhere herein, such as in connection with FIGS. 3A-3C.

As shown by reference number 420, the process 400 may include estimating a reaction time of the driver of the vehicle 110. For example, the reaction time of the driver of the vehicle 110 may be estimated based on generic and/or personalized historical data of reaction times and generated recommendations (e.g., as shown by reference number 425), such as data stored in the reaction time database 120, as described in more detail elsewhere herein. Additionally, or alternatively, the reaction time of the driver of the vehicle 110 may be estimated based on vehicle data 430 (such as a speed of the vehicle 110), a distance between the vehicle 110 and a potential hazard, weather conditions, road conditions, and/or other vehicle data. Additionally, or alternatively, the reaction time of the driver of the vehicle 110 may be estimated based on the one or more reaction time risk indicators, as described in more detail elsewhere herein.

As shown by reference number 435, the process 400 may include generating one or more recommendations based on the estimated reaction time of the driver and/or on the one or more reaction time risk indicators. For example, the process 400 may include generating advice or recommendations for a driving automation system (e.g., an ADAS or an ADS) of the vehicle 110 based on the estimated reaction time of the driver and/or on the one or more reaction time risk indicators. As shown by reference number 440, the process 400 may include providing the one or more recommendations, the estimated reaction time of the driver, and/or the one or more reaction time risk indicators to the driving automation system.

As shown by reference number 445, the process 400 may include collecting reaction times and generated recommendations as part of a feedback loop, as described in more detail elsewhere herein. For example, the reaction times and/or generated recommendations (e.g., the generated recommendations for a scenario in which the reaction time is measured) may be stored in the reaction time database 120.

As indicated above, FIG. 4 is provided as an example. Other examples may differ from what is described with regard to FIG. 4.

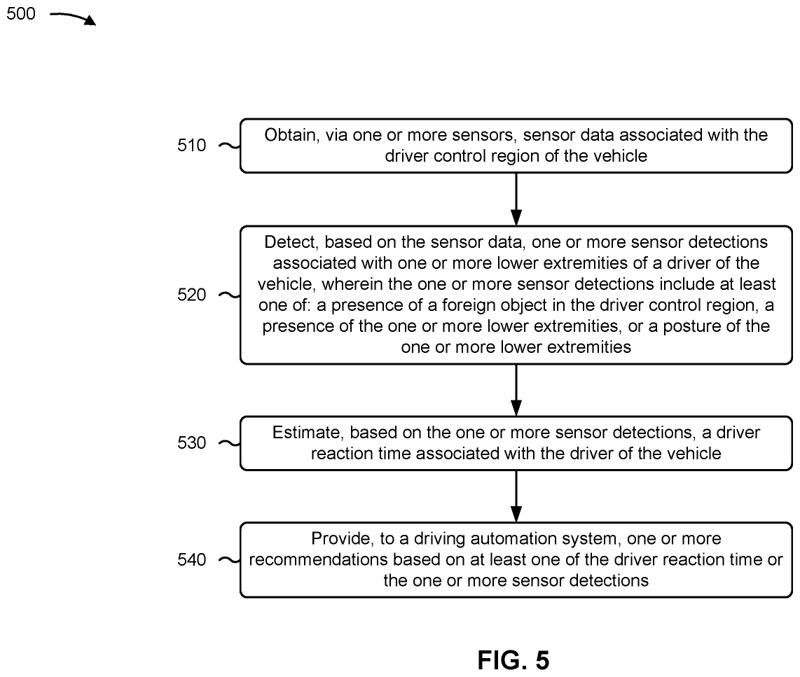

FIG. 5 is a flowchart of an example process 500 associated with driver assistance recommendations using sensor data associated with a lower extremity region. In some aspects, one or more process blocks of FIG. 5 are performed by a device (e.g., the vehicle 110 and/or the controller 112). In some implementations, one or more process blocks of FIG. 5 are performed by another device or a group of devices separate from or including the device, such as the reaction time database 120. Additionally, or alternatively, one or more process blocks of FIG. 5 may be performed by one or more components of device 200, such as processor 210, memory 215, input component 220, output component 225, communication component 230, camera 235, and/or sensor(s) 240.

As shown in FIG. 5, process 500 may include obtaining, via one or more sensors, sensor data associated with the driver control region of the vehicle (block 510). For example, the device may obtain, via one or more sensors, sensor data associated with the driver control region of the vehicle, as described above. In some aspects, the driver control region includes at least one of an accelerator component or a braking component associated with the vehicle 110.

As further shown in FIG. 5, process 500 may include detecting, based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities (block 520). For example, the device may detect, based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities, as described above.

As further shown in FIG. 5, process 500 may include estimating, based on the one or more sensor detections, a driver reaction time associated with the driver of the vehicle (block 530). For example, the device may estimate, based on the one or more sensor detections, a driver reaction time associated with the driver of the vehicle, as described above.

As further shown in FIG. 5, process 500 may include providing, to a driving automation system, one or more recommendations based on at least one of the driver reaction time or the one or more sensor detections (block 540). For example, the device may provide, to a driving automation system, one or more recommendations based on at least one of the driver reaction time or the one or more sensor detections, as described above.

Process 500 may include additional aspects, such as any single aspect or any combination of aspects described below and/or in connection with one or more other processes described elsewhere herein.

In a first aspect, process 500 includes determining, based on the posture of the one or more lower extremities, that the one or more lower extremities are positioned in a trigger posture.

In a second aspect, alone or in combination with the first aspect, process 500 includes applying, based on determining that the one or more lower extremities are positioned in the trigger posture, a scaling factor to an estimated driver reaction time to obtain the driver reaction time.

In a third aspect, alone or in combination with one or more of the first and second aspects, process 500 includes obtaining an indication of an actual reaction time of the driver, and storing, in a reaction time database, an indication of the actual reaction time in connection with at least one of the one or more recommendations or the one or more sensor detections.

In a fourth aspect, alone or in combination with one or more of the first through third aspects, process 500 includes estimating the driver reaction time based on the one or more sensor detections and data stored in the reaction time database.

In a fifth aspect, alone or in combination with one or more of the first through fourth aspects, process 500 includes increasing, based on detecting the presence of the foreign object, an estimated driver reaction time to obtain the driver reaction time.

In a sixth aspect, alone or in combination with one or more of the first through fifth aspects, the one or more recommendations include at least one of adjusting a speed of the vehicle, displaying a warning message, adjusting one or more parameters of the driving automation system, or causing the vehicle to safely stop operations.

In a seventh aspect, alone or in combination with one or more of the first through sixth aspects, process 500 includes determining, based on detecting the presence of the foreign object, a risk score associated with the foreign object based on at least one of: a type or category associated with the foreign object, a size of the foreign object, a position of the foreign object relative to the one or more lower extremities, or a position of the foreign object relative to at least one of the accelerator component or the braking component.

In an eighth aspect, alone or in combination with one or more of the first through seventh aspects, the driver reaction time is based on the risk score.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

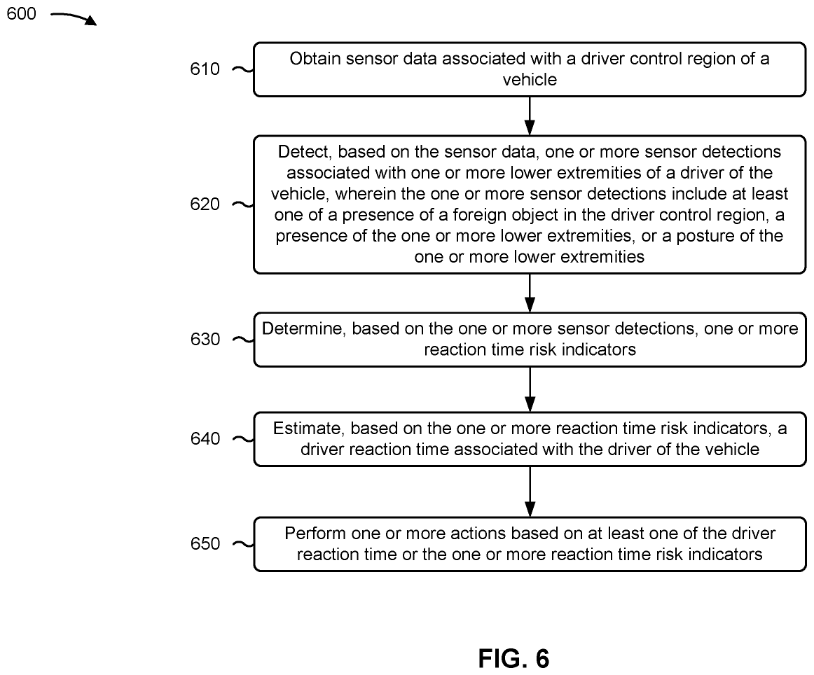

FIG. 6 is a flowchart of an example process 600 associated with driver assistance recommendations using sensor data associated with a lower extremity region. In some aspects, one or more process blocks of FIG. 6 are performed by a device (e.g., the vehicle 110 and/or the controller 112). In some aspects, one or more process blocks of FIG. 6 are performed by another device or a group of devices separate from or including the device, such as the reaction time database 120. Additionally, or alternatively, one or more process blocks of FIG. 6 may be performed by one or more components of device 200, such as processor 210, memory 215, input component 220, output component 225, communication component 230, camera 235, and/or sensor(s) 240.

As shown in FIG. 6, process 600 may include obtaining sensor data associated with a driver control region of a vehicle (block 610). For example, the device may obtain sensor data associated with a driver control region of a vehicle, as described above.

As further shown in FIG. 6, process 600 may include detecting, based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities (block 620). For example, the device may detect, based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities, as described above.

As further shown in FIG. 6, process 600 may include determining, based on the one or more sensor detections, one or more reaction time risk indicators (block 630). For example, the device may determine, based on the one or more sensor detections, one or more reaction time risk indicators, as described above.

As further shown in FIG. 6, process 600 may include estimating, based on the one or more reaction time risk indicators, a driver reaction time associated with the driver of the vehicle (block 640). For example, the device may estimate, based on the one or more reaction time risk indicators, a driver reaction time associated with the driver of the vehicle, as described above.

As further shown in FIG. 6, process 600 may include performing one or more actions based on at least one of the driver reaction time or the one or more reaction time risk indicators (block 650). For example, the device may perform one or more actions based on at least one of the driver reaction time or the one or more reaction time risk indicators, as described above.

Process 600 may include additional aspects, such as any single aspect or any combination of aspects described below and/or in connection with one or more other processes described elsewhere herein.

In a first aspect, the sensor data includes at least one of camera data, LIDAR data, radar data, or ultrasonic sensor data.

In a second aspect, alone or in combination with the first aspect, estimating the driver reaction time includes determining a first driver reaction time based on at least one of one or more parameters of the vehicle or information associated with an upper body of the driver, and modifying the first driver reaction time to obtain the driver reaction time based on the one or more reaction time risk indicators.

In a third aspect, alone or in combination with one or more of the first and second aspects, the one or more reaction time risk indicators include at least one of: a position or type associated with the foreign object, the posture of the one or more lower extremities being associated with a trigger posture, or the sensor data indicating a lack of the presence of the one or more lower extremities.

In a fourth aspect, alone or in combination with one or more of the first through third aspects, performing the one or more actions includes providing, to a driving automation system of the vehicle, an indication of at least one of the driver reaction time, the one or more reaction time risk indicators, or one or more recommendations that are based on at least one of the driver reaction time or the one or more reaction time risk indicators.

In a fifth aspect, alone or in combination with one or more of the first through fourth aspects, performing the one or more actions includes adjusting a speed of the vehicle, displaying a warning message, adjusting one or more parameters of a driving automation system, or causing the vehicle to safely stop operations.

In a sixth aspect, alone or in combination with one or more of the first through fifth aspects, determining the one or more reaction time risk indicators includes determining that a foot of the driver that is used to operate an accelerator component or a brake component of the vehicle by the driver is obstructed by another extremity included in the one or more lower extremities or by the foreign object relative to the accelerator component or the brake component.

In a seventh aspect, alone or in combination with one or more of the first through sixth aspects, the one or more reaction time risk indicators include that the one or more lower extremities are not detected in the driver control region of the vehicle, and performing the one or more actions includes at least one of displaying a warning message requesting the driver to return the one or more lower extremities to the driver control region, or causing the vehicle to safely stop movement.

In an eighth aspect, alone or in combination with one or more of the first through seventh aspects, performing the one or more actions includes providing, to a driving automation system of the vehicle, information based on the driver reaction time or the one or more reaction time risk indicators in accordance with a periodic schedule or based on detecting a trigger event.

In a ninth aspect, alone or in combination with one or more of the first through eighth aspects, the trigger event is associated with determining the one or more reaction time risk indicators.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A device, comprising: one or more sensors configured to monitor a driver control region of a vehicle; one or more memories; and one or more processors, coupled to the one or more memories, configured to: obtain, via the one or more sensors, sensor data associated with the driver control region of the vehicle, wherein the driver control region includes at least one of an accelerator component or a braking component associated with the vehicle; detect, based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities; estimate, based on the one or more sensor detections, a driver reaction time associated with the driver of the vehicle; and provide, to a driving automation system, one or more recommendations based on at least one of the driver reaction time or the one or more sensor detections.

Aspect 2: The device of Aspect 1, wherein the one or more processors, to detect the one or more sensor detections, are configured to: determine, based on the posture of the one or more lower extremities, that the one or more lower extremities are positioned in a trigger posture.

Aspect 3: The device of Aspect 2, wherein the one or more processors, to estimate the driver reaction time, are configured to: apply, based on determining that the one or more lower extremities are positioned in the trigger posture, a scaling factor to an estimated driver reaction time to obtain the driver reaction time.

Aspect 4: The device of any of Aspects 1-3, wherein the one or more processors are further configured to: obtain an indication of an actual reaction time of the driver; and store, in a reaction time database, an indication of the actual reaction time in connection with at least one of the one or more recommendations or the one or more sensor detections.

Aspect 5: The device of Aspect 4, wherein the one or more processors, to estimate the driver reaction time, are configured to: estimate the driver reaction time based on the one or more sensor detections and data stored in the reaction time database.

Aspect 6: The device of any of Aspects 1-5, wherein the one or more processors, to estimate the driver reaction time, are configured to: increase, based on detecting the presence of the foreign object, an estimated driver reaction time to obtain the driver reaction time.

Aspect 7: The device of any of Aspects 1-6, wherein the one or more recommendations include at least one of: to adjust a speed of the vehicle, to display a warning message, to adjust one or more parameters of the driving automation system, or to cause the vehicle to safely stop operations.

Aspect 8: The device of any of Aspects 1-7, wherein the one or more processors are further configured to: determine, based on detecting the presence of the foreign object, a risk score associated with the foreign object based on at least one of: a type or category associated with the foreign object, a size of the foreign object, a position of the foreign object relative to the one or more lower extremities, or a position of the foreign object relative to at least one of the accelerator component or the braking component.

Aspect 9: The device of Aspect 8, wherein the driver reaction time is based on the risk score.

Aspect 10: A method, comprising: obtaining, by a device, sensor data associated with a driver control region of a vehicle; detecting, by the device and based on the sensor data, one or more sensor detections associated with one or more lower extremities of a driver of the vehicle, wherein the one or more sensor detections include at least one of: a presence of a foreign object in the driver control region, a presence of the one or more lower extremities, or a posture of the one or more lower extremities; determining, by the device and based on the one or more sensor detections, one or more reaction time risk indicators; estimating, by the device and based on the one or more reaction time risk indicators, a driver reaction time associated with the driver of the vehicle; and performing, by the device, one or more actions based on at least one of the driver reaction time or the one or more reaction time risk indicators.

Aspect 11: The method of Aspect 10, wherein the sensor data includes at least one of: camera data, light detection and ranging (LIDAR) data, radar data, or ultrasonic sensor data.

Aspect 12: The method of any of Aspects 10-11, wherein estimating the driver reaction time comprises: determining a first driver reaction time based on at least one of one or more parameters of the vehicle or information associated with an upper body of the driver; and modify the first driver reaction time to obtain the driver reaction time based on the one or more reaction time risk indicators.

Aspect 13: The method of any of Aspects 10-12, wherein the one or more reaction time risk indicators include at least one of: a position or type associated with the foreign object, the posture of the one or more lower extremities being associated with a trigger posture, or the sensor data indicating a lack of the presence of the one or more lower extremities.

Aspect 14: The method of any of Aspects 10-13, wherein performing the one or more actions comprises: providing, to a driving automation system of the vehicle, an indication of at least one of: the driver reaction time, the one or more reaction time risk indicators, or one or more recommendations that are based on at least one of the driver reaction time or the one or more reaction time risk indicators.

Aspect 15: The method of any of Aspects 10-14, wherein performing the one or more actions comprises: adjusting a speed of the vehicle, displaying a warning message, adjusting one or more parameters of a driving automation system, or causing the vehicle to safely stop operations.

Aspect 16: The method of any of Aspects 10-15, wherein determining the one or more reaction time risk indicators comprises: determining that a foot of the driver that is used to operate an accelerator component or a brake component of the vehicle by the driver is obstructed by another extremity included in the one or more lower extremities or by the foreign object relative to the accelerator component or the brake component.

Aspect 17: The method of any of Aspects 10-16, wherein the one or more reaction time risk indicators include that the one or more lower extremities are not detected in the driver control region of the vehicle, and wherein performing the one or more actions comprises at least one of: displaying a warning message requesting the driver to return the one or more lower extremities to the driver control region; or causing the vehicle to safely stop movement.

Aspect 18: The method of any of Aspects 10-17, wherein performing the one or more actions comprises: providing, to a driving automation system of the vehicle, information based on the driver reaction time or the one or more reaction time risk indicators in accordance with a periodic schedule or based on detecting a trigger event.

Aspect 19: The method of Aspect 18, wherein the trigger event is associated with determining the one or more reaction time risk indicators.

Aspect 20: A system configured to perform one or more operations recited in one or more of Aspects 1-19.

Aspect 21: An apparatus comprising means for performing one or more operations recited in one or more of Aspects 1-19.

Aspect 22: A non-transitory computer-readable medium storing a set of instructions, the set of instructions comprising one or more instructions that, when executed by a device, cause the device to perform one or more operations recited in one or more of Aspects 1-19.

Aspect 23: A computer program product comprising instructions or code for executing one or more operations recited in one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. Also, “determining” can include resolving, selecting, obtaining, choosing, establishing and other such similar actions.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
one or more sensors configured to monitor a driver control region of a vehicle;
one or more memories; and
one or more processors, coupled to the one or more memories, configured to:
obtain, via the one or more sensors, sensor data associated with the driver control region of the vehicle,
wherein the driver control region includes at least one of an accelerator component or a braking component associated with the vehicle;
detect, based on the sensor data, one or more sensor detections associated with one or more lower extremities of a driver of the vehicle, wherein the one or more sensor detections include at least one of:
a presence of a foreign object in the driver control region,
a presence of the one or more lower extremities, or
a posture of the one or more lower extremities;
estimate, based on the one or more sensor detections, a driver reaction time associated with the driver of the vehicle; and
provide, to a driving automation system, one or more recommendations based on at least one of the driver reaction time or the one or more sensor detections.

2. The device of claim 1, wherein the one or more processors, to detect the one or more sensor detections, are configured to:
determine, based on the posture of the one or more lower extremities, that the one or more lower extremities are positioned in a trigger posture.

3. The device of claim 2, wherein the one or more processors, to estimate the driver reaction time, are configured to:
apply, based on determining that the one or more lower extremities are positioned in the trigger posture, a scaling factor to an estimated driver reaction time to obtain the driver reaction time.

4. The device of claim 1, wherein the one or more processors are further configured to:
obtain an indication of an actual reaction time of the driver; and
store, in a reaction time database, an indication of the actual reaction time in connection with at least one of the one or more recommendations or the one or more sensor detections.

5. The device of claim 4, wherein the one or more processors, to estimate the driver reaction time, are configured to:
estimate the driver reaction time based on the one or more sensor detections and data stored in the reaction time database.

6. The device of claim 1, wherein the one or more processors, to estimate the driver reaction time, are configured to:
increase, based on detecting the presence of the foreign object, an estimated driver reaction time to obtain the driver reaction time.

7. The device of claim 1, wherein the one or more recommendations include at least one of:
to adjust a speed of the vehicle,
to display a warning message,
to adjust one or more parameters of the driving automation system, or to cause the vehicle to safely stop operations.

8. The device of claim 1, wherein the one or more processors are further configured to:
determine, based on detecting the presence of the foreign object, a risk score associated with the foreign object based on at least one of:
a type or category associated with the foreign object,
a size of the foreign object,
a position of the foreign object relative to the one or more lower extremities, or
a position of the foreign object relative to at least one of the accelerator component or the braking component.

9. The device of claim 8, wherein the driver reaction time is based on the risk score.

10. A method, comprising:
obtaining, by a device, sensor data associated with a driver control region of a vehicle;
detecting, by the device and based on the sensor data, one or more sensor detections associated with one or more lower extremities of a driver of the vehicle, wherein the one or more sensor detections include at least one of:
a presence of a foreign object in the driver control region,
a presence of the one or more lower extremities, or
a posture of the one or more lower extremities;
determining, by the device and based on the one or more sensor detections, one or more reaction time risk indicators;
estimating, by the device and based on the one or more reaction time risk indicators, a driver reaction time associated with the driver of the vehicle; and
performing, by the device, one or more actions based on at least one of the driver reaction time or the one or more reaction time risk indicators.

11. The method of claim 10, wherein the sensor data includes at least one of:
camera data,
light detection and ranging (LIDAR) data,
radar data, or
ultrasonic sensor data.

12. The method of claim 10, wherein estimating the driver reaction time comprises:
determining a first driver reaction time based on at least one of one or more parameters of the vehicle or information associated with an upper body of the driver; and
modify the first driver reaction time to obtain the driver reaction time based on the one or more reaction time risk indicators.

13. The method of claim 10, wherein the one or more reaction time risk indicators include at least one of:
a position or type associated with the foreign object,
the posture of the one or more lower extremities being associated with a trigger posture, or
the sensor data indicating a lack of the presence of the one or more lower extremities.

14. The method of claim 10, wherein performing the one or more actions comprises:
providing, to a driving automation system of the vehicle, an indication of at least one of:
the driver reaction time,
the one or more reaction time risk indicators, or
one or more recommendations that are based on at least one of the driver reaction time or the one or more reaction time risk indicators.

15. The method of claim 10, wherein performing the one or more actions comprises:
adjusting a speed of the vehicle,
displaying a warning message,
adjusting one or more parameters of a driving automation system, or
causing the vehicle to safely stop operations.

16. The method of claim 10, wherein determining the one or more reaction time risk indicators comprises:
determining that a foot of the driver that is used to operate an accelerator component or a brake component of the vehicle by the driver is obstructed by another extremity included in the one or more lower extremities or by the foreign object relative to the accelerator component or the brake component.

17. The method of claim 10, wherein the one or more reaction time risk indicators include that the one or more lower extremities are not detected in the driver control region of the vehicle, and wherein performing the one or more actions comprises at least one of:
displaying a warning message requesting the driver to return the one or more lower extremities to the driver control region; or
causing the vehicle to safely stop movement.

18. The method of claim 10, wherein performing the one or more actions comprises:
providing, to a driving automation system of the vehicle, information based on the driver reaction time or the one or more reaction time risk indicators in accordance with a periodic schedule or based on detecting a trigger event.

19. The method of claim 18, wherein the trigger event is associated with determining the one or more reaction time risk indicators.

20. A non-transitory computer-readable medium storing a set of instructions, the set of instructions comprising:
one or more instructions that, when executed by one or more processors of a device, cause the device to:
obtain sensor data associated with a driver control region of a vehicle,
wherein the driver control region includes at least one of an accelerator component or a braking component associated with the vehicle;
detect, based on the sensor data, one or more sensor detections associated with one or more lower extremities of a driver of the vehicle, wherein the one or more sensor detections include at least one of:
a presence of a foreign object in the driver control region,
a presence of the one or more lower extremities, or
a posture of the one or more lower extremities;
estimate, based on the one or more sensor detections, a driver reaction time associated with the driver of the vehicle; and
provide, to a driving automation system, one or more recommendations based on at least one of the driver reaction time or the one or more sensor detections.

21. The non-transitory computer-readable medium of claim 20, wherein the one or more instructions, that cause the device to detect the one or more sensor detections, cause the device to:
determine, based on the posture of the one or more lower extremities, that the one or more lower extremities are positioned in a trigger posture that is associated with an increased reaction time of the driver.

22. The non-transitory computer-readable medium of claim 21, wherein the one or more instructions, that cause the device to estimate the driver reaction time, cause the device to:
increase, based on determining that the one or more lower extremities are positioned in the trigger posture, an estimated driver reaction time to obtain the driver reaction time.

23. The non-transitory computer-readable medium of claim 20, wherein the one or more instructions further cause the device to:
obtain an indication of an actual reaction time of the driver; and
store, in a reaction time database, an indication of the actual reaction time in connection with at least one of the one or more recommendations or the one or more sensor detections.

24. The non-transitory computer-readable medium of claim 23, wherein the one or more instructions, that cause the device to estimate the driver reaction time, cause the device to:
estimate the driver reaction time based on the one or more sensor detections and data stored in the reaction time database.

25. An apparatus, comprising:
means for obtaining sensor data associated with a driver control region of a vehicle;
means for detecting, based on the sensor data, one or more sensor detections associated with one or more lower extremities of a driver of the vehicle, wherein the one or more sensor detections include at least one of:
a presence of a foreign object in the driver control region,
a presence of the one or more lower extremities, or
a posture of the one or more lower extremities;
means for determining, based on the one or more sensor detections, one or more reaction time risk indicators;
means for estimating, based on the one or more reaction time risk indicators, a driver reaction time associated with the driver of the vehicle; and
means for performing one or more actions based on at least one of the driver reaction time or the one or more reaction time risk indicators.

26. The apparatus of claim 25, wherein the means for estimating the driver reaction time comprises:
means for determining a first driver reaction time based on at least one of one or more parameters of the vehicle or information associated with an upper body of the driver; and
means for applying a scaling factor to the first driver reaction time to obtain the driver reaction time, wherein the scaling factor is based on the one or more reaction time risk indicators.

27. The apparatus of claim 25, wherein the one or more reaction time risk indicators include at least one of:
a position or type associated with the foreign object,
the posture of the one or more lower extremities being associated with a trigger posture, or
the sensor data indicating a lack of the presence of the one or more lower extremities.

28. The apparatus of claim 25, wherein the means for performing the one or more actions comprises:
means for providing, to a driving automation system of the vehicle, an indication of at least one of:
the driver reaction time,
the one or more reaction time risk indicators, or
one or more recommendations that are based on at least one of the driver reaction time or the one or more reaction time risk indicators.

29. The apparatus of claim 25, wherein the means for performing the one or more actions comprises:
means for adjusting a speed of the vehicle,
means for displaying a warning message,
means for adjusting one or more parameters of a driving automation system, or
means for causing the vehicle to safely stop operations.

30. The apparatus of claim 25, wherein the means for determining the one or more reaction time risk indicators comprises:
means for determining that a foot of the driver that is used to operate an accelerator component or a brake component of the vehicle by the driver is obstructed by another extremity included in the one or more lower extremities or by the foreign object relative to the accelerator component or the brake component.
